(19) United States
(12) Patent Application Publication
(10) Pub. No.: US 2010/0254139 A1
(43) Pub. Date: Oct. 7, 2010

(54) OMNIDIRECTIONAL LIGHT BULB USING LIGHT EMITTING DIODE

(76) Inventor: Der-Ming JUANG, Sindian City (TW)

Correspondence Address: LEONG C LEI, PMB # 1008, 1867 YGNACIO VALLEY ROAD, WALNUT CREEK, CA, 94598, US

(21) Appl. No.: 12/416,165

(22) Filed: Apr. 1, 2009

(51) Int. Cl. F21S 4/00

(52) U.S. Cl. 362/249.02

(57) ABSTRACT

The light bulb contains a transparent body member and a contact member at an end of the body member that could be screwed into a conventional light bulb socket for establishing electrical connections. Inside the transparent member, there are a number of circuit boards, each having a circular end and a rectangular body. Around the circumference of a side of the circular end, a number of LEDs are provided at appropriate spacing to project light towards various centrifugal directions, respectively. The circuit boards intersect with each other along a vertical direction so as to form a cross shape, a star shape, or a similar, radiating-from-a-center shape.

### BACKGROUND OF THE INVENTION

1. Field of the Invention

The present invention generally relates to light bulbs, and more particularly to a light bulb using light emitting diodes as light source and projecting light in substantially all directions.

2. Description of Related Art

Light emitting diodes (LEDs), due to their low power consumption, significantly less heat generation, and long life span, have been widely employed in various lighting applications. However, the light emanated by a LED is usually restricted in a limited range and, as such, most of the applications utilizing LEDs are projection-based, such as flashlights, vehicle lamps, streetlamps, etc. In contrast, the incandescent light bulbs commonly found in households produce omnidirectional light from heated filaments. Therefore, if the LEDs are to replace incandescent light bulbs in household applications, the problem of limited coverage has to be addressed.

### BRIEF SUMMARY OF THE INVENTION

A novel light bulb using LEDs as light source capable of producing substantially omnidirectional light is provided herein.

The light bulb contains a transparent body member and a contact member at an end of the body member that could be screwed into a conventional light bulb socket for establishing electrical connections. The light bulb also contains a number of flat circuit boards having a circular end and a rectangular body whose width is smaller than the diameter of the circular end. Two or more LEDs are arranged at appropriate space along the circumference of a side of the circular end and the light from these LEDs are projected towards centrifugal directions. The circuit boards are joined to intersect each other along a vertical direction so that, when viewed from the circular end towards the rectangular body, the circuit boards from a cross shape, a star shape, or a similar, radiating-from-a-center shape.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a side-view diagram showing an omnidirectional light bulb according a first embodiment of the present invention.

FIG. 1b is a top-view diagram showing the omnidirectional light bulb of FIG. 1a.

FIG. 1c is a schematic diagram showing the circuit boards of the omnidirectional light bulb of FIG. 1a.

FIG. 2a is a top-view diagram showing an omnidirectional light bulb according a second embodiment of the present invention.

FIG. 2b is a schematic diagram showing the circuit boards of the omnidirectional light bulb of FIG. 2a.

### DETAILED DESCRIPTION OF THE INVENTION

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

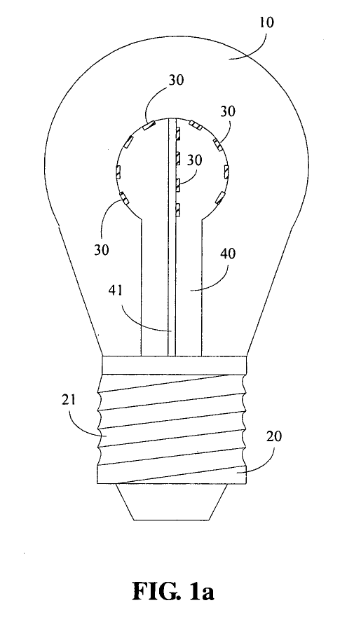

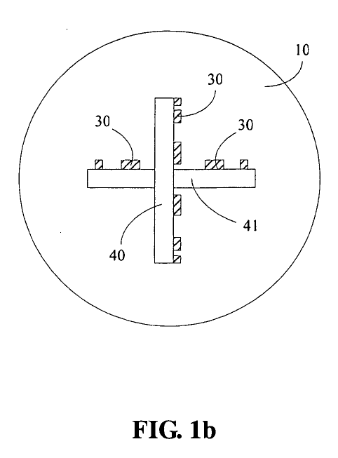

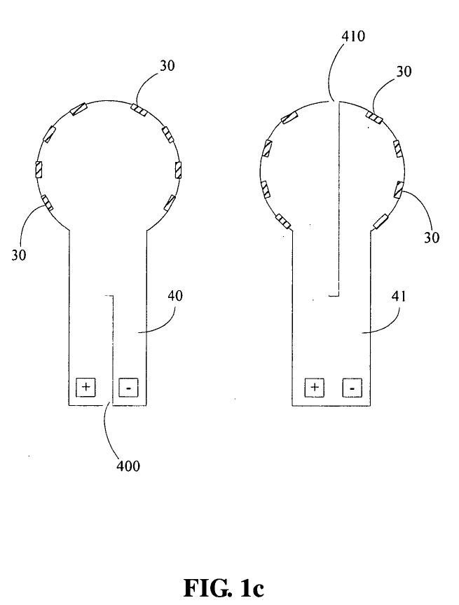

As shown in FIG. 1a, an omnidirectional light bulb according a first embodiment of the present invention mainly contains a transparent body member 10. The body member 10 could be hollow or solid and could have the usual spherical shape of ordinary light bulbs or other appropriate shape.

To an end of the body member 10, there is a contact member 20 with threads 21 for screwing into an ordinary light bulb socket (not shown). The contact member 20, like all ordinary light bulbs, has two electrical contact points, one being the threads 21 and the other one at a bottom end of the contact member 20 (also not shown), so as to establish electrical connections with the light bulb socket. Inside the contact member 20, there could be circuits for electrical rectification and regulation and overload protection, etc. For people skilled in the related arts, these details are quite straightforward and therefore are omitted in the present specification and the accompanied drawings.

The light bulb further contains a number of circuit boards inside the body member 10. In the present embodiment, there are two circuit boards 40 and 41. Each circuit board is flat, and has a circular end and a rectangular body. The width of the rectangular body is smaller than the diameter of the circular end. A number of LEDs 30 are positioned along the circumference on a side of the circular end at appropriate spacing therebetween. These LEDs 30 are configured so that their light is projected towards various centrifugal directions away from the center of the circular end, respectively. As illustrate in the top-view diagram of FIG. 1b, the two circuit boards 40 and 41 join and intersect each other along a vertical direction with a 90-degree included angle. Therefore, if looking down on the combination of the circuit boards 40 and 41 from their circular ends, a cross shape is formed by the circular boards 40 and 41.

As shown in FIG. 1a, for a circuit board 40 or 41, as its LEDs 30 are arranged along the circular end's circumference, their light projections substantially cover the entire 360-degree range along a plane coplanar with the circuit board 40 or 41. As shown in FIG. 1b, for a plane that is perpendicular to the circuit boards 40 and 41, its 360-degree range would be covered by more than one LED 30. In the present embodiment, if the LEDs are arranged at the same locations on both the circuit boards 40 and 41, the light from up to four LEDs 30 should cover the 360-degree range of such a plane. Combing the two effects together, the LEDs 30 of the present embodiment should jointly constitute a substantially omnidirectional light coverage, therefore resolving the limited coverage problem of the prior art. As can be imagined, if there are more LEDs 30 on the circuit boards 40 and 41 with smaller spacing therebetween, the light bulb should have stronger brightness and a light coverage approaching true omnidirection.

Further, as shown in FIGS. 1a and 1b, to save cost without sacrificing the light coverage, the LEDs 30 on separate circuit boards 40 and 41 could be arranged in an interleaving manner. In other words, two neighboring LEDs 30 from the circuit boards 40 and 41 are not at the same height, so as to avoid their light from overlapping.

As shown in FIG. 1c, the circuit board 40 has an elongated and vertical slot 400 whose one end borders on a bottom rim of its rectangular body. Correspondingly, the circuit board 41 has another elongated and vertical slot 410 whose one end borders on a top rim of its circular end. Please note that the slots 400 and 410 have matched lengths and the sum of their lengths equals to the height of the circuit boards 40 and 41. Therefore, by aligning and plugging the slots 400 and 410 together, the circuit boards 40 and 41 would form the intersecting configuration as shown in FIGS. 1a and 1b.

The attachment of the circuit boards 40 and 41 to the contact member 20 could be achieved in various ways. In one embodiment, a cross-shaped socket is provided on the contact member 20 and the intersecting circuit boards 40 and 41 could be directly plugged into the cross-shaped socket. Please note that the circuit boards 40 and 41 should have circuits for driving the LEDs 30 (but they are omitted in the drawings for simplicity) and these circuits should have electrical contact points (as denoted by the ‘+’ and ‘−’ signs in the drawing) for receiving electricity. As such, when the intersecting circuit boards 40 and 41 are plugged into the cross-shaped socket of the contact member 20, the electrical contact points on the circuit boards 40 and 41 would connect to the rectifying and regulating circuits inside the contact member 20 and the LEDs 30 on the circuit boards 40 and 41 are thereby powered. For persons skilled in the related art, these details should be quite straightforward and therefore is omitted here.

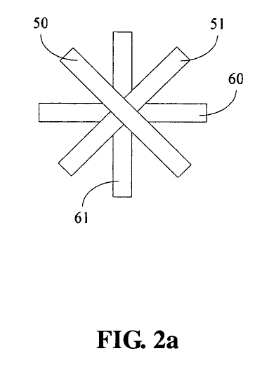

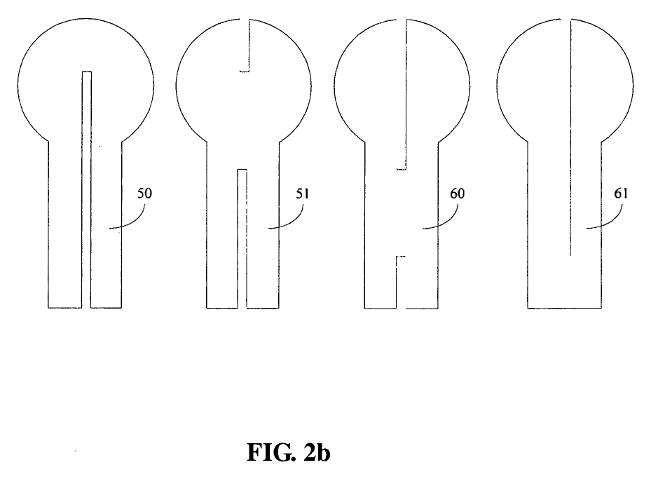

FIGS. 2a and 2b show a second embodiment of the present invention. For simplicity, those parts identical to the first embodiment are omitted such as the LEDs 30 and the ‘+’ and ‘−’ contact points. As illustrated in FIG. 2a, the present embodiment has four circuit boards 50, 51, 60, and 61. They join and intersect with each other along a vertical direction with 45-degree included angles between neighboring boards. Therefore, when viewed from the circular ends of the circuit boards 50, 51, 60, and 61, a star shape from the top-view perspective is formed.

The circuit boards 50, 51, 60, and 61 are shown in FIG. 2b, each having an elongated slot for their intersection. With these slots, the slot on the rectangular body of the circuit board 50 could be plugged into the slot at the circular end of the circuit board 51. The slots on the rectangular bodies of the circuit boards 50 and 51 are then plugged into the slot at the circular end of the circuit board 60. Finally, the slots on the rectangular bodies of the circuit boards 50, 51, and 60 are then plugged into the slot at the circular end of the circuit board 61. The result is therefore the star shape as shown in FIGS. 2a and 2b.

It could be imagined that there could be embodiments incorporating six, eight, or even more circuit boards. It is also possible to intersect three, five, seven, or larger odd-numbered circuit boards to a form a radiating-from-a-center shape from the top-view perspective. As there are more circuit boards, for a plane perpendicular to the circuit boards, there will be more LEDs 30 to cover the 360-degree range of the plane. The light bulb therefore would have more complete lateral light coverage and, as such, approach the true omnidirection.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An omnidirectional light bulb using LEDs as light source, comprising:
a transparent body member;
a contact member at an end of said body member, said contract member having a plurality of threads and electrical contacts along an outer surface for screwing into a light bulb socket for establishing electrical connectivity; and
a plurality of flat circuit boards inside said body member, each having a circular end, a rectangular body whose width is smaller than the diameter of said circular end, and a plurality of LEDs on each circuit board positioned at appropriate spacing along the circumference on a side of said circular end and configured to project light towards various centrifugal directions away from the center of said circular end, respectively, said circuit boards intersecting each other along a vertical direction to form a radiating-from-a-center shape from a top-view perspective;
wherein said circuit boards join to said contact member by their rectangular bodies; each of said circuit boards has electrical contact points on said rectangular body so as to establish electrical connection with said contact member.

2. The omnidirectional light bulb according to claim 1, wherein there are even-numbered circuit boards.

3. The omnidirectional light bulb according to claim 2, wherein there are two circuit boards; and said two circuit boards intersect with each along a vertical direction to form a cross shape from a top-view perspective.

4. The omnidirectional light bulb according to claim 2, wherein there are four circuit boards; and said four circuit boards intersect with each along a vertical direction to form a star shape from a top-view perspective.
